(19) United States
(12) Patent Application Publication
(10) Pub. No.: US 2010/0032118 A1
(43) Pub. Date: Feb. 11, 2010

(54) Measuring roll for a fibre-web machine, advantageously for a reel-up of a fibre web

(76) Inventors: Petteri Lannes, Jokela (FI); Tatu Pitkanen, Jarvenpaa (FI); Jari Tiitta, Kellokoski (FI); Marko Tiilikainen, Kellokoski (FI); Teppo Kojo, Mantsala (FI); Reijo Huuskonen, Tikkakoski (FI)

Correspondence Address: OLIFF & BERRIDGE, PLC, P.O. BOX 320850, ALEXANDRIA, VA, 22320-4850, US

(21) Appl. No.: 12/448,361

(22) PCT Filed: Dec. 4, 2007
(86) PCT No.: PCT/FI2007/050656

§ 371 Date: Oct. 9, 2009

(30) Foreign Application Priority Data
Dec. 21, 2006 (FI) 20065836

(51) Int. Cl. D21F 7/06; B05D 1/36; B32B 43/00

(52) U.S. Cl. 162/263; 427/402; 427/140

(57) ABSTRACT

The invention relates to a measuring roll for a fibre-web machine, which roll has a shell on whose surface a sensor is arranged, and which roll is coated with a coating layer proper. The roll comprises at least one protective coating layer placed under the coating layer proper and on top of the sensor in such a way that when the coating layer proper is replaced, the protective coating layer remains substantially on top of the sensor and the roll shell when the coating layer proper is removed. The invention also relates to a method for coating a measuring roll of a fibre-web machine and to a method for replacing a coating of a measuring roll of a fibre-web machine.

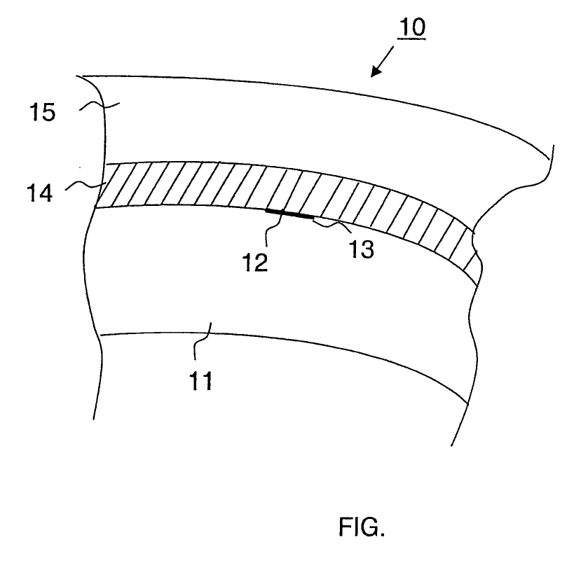

The invention relates to a measuring roll for a fibre-web machine, advantageously for a reel-up of a fibre-web, according to the preamble of claim 1.

The invention also relates to a method for coating a measuring roll of a fibre-web machine according to the preamble of claim 10.

In addition, the invention relates to a method for replacing a coating of a measuring roll of a fibre-web machine according to the preamble of claim 11.

In the prior art there are known reel-ups for use in connection with fibre-web machines, such as paper and board machines, the fibre web manufactured on the fibre-web machines, such as a paper machine/a board machine, being reeled as a full-width web into machine reels for further processing. The web is reeled about a reeling drum, for example, a reel spool either by means of surface drive in a reeling nip between a reel drum and the wound web reel or making use of centre drive, in which case the reeling drum is also provided with a drive. In connection with fibre-web machines, such as paper and board machines, unwinds are also used, by which the web reel wound on a reel-up is unwound at a later stage for further processing of the fibre web.

With respect to the state of the art, reference can be made to FI patent application 20055020, which discloses a method for measuring a nip pressure and/or a pressure profile. In the method, a nip-forming roll is fitted with a pressure sensor under a protective coating layer which functions on top of the sensor, and nip pressure causes a deformation proportional to the nip pressure in the bottom surface of the coating and the deformation compresses the sensor, which responds to the deformation by generating an electric signal. The publication also describes a roil for measuring a nip pressure and/or a pressure profile, which roll is provided with a pressure sensor placed under a protective coating layer that functions as a spring, and in which at least one coating layer consists of a cold-curing polymer or composite. According to the publication, the sensor is shielded by a cold-curing polymer coating, and on top of the sensor there is one or more coating layers, when using two coating layers, the bottom one is provided with a groove for the sensor, in which case the uppermost layer can also be hot-curing. The publication describes an arrangement in which the lower coating provided with a groove for the sensor is made of a relatively hard material or of a material having an elasticity equal to the sensor itself. The publication mentions coating hardnesses of 10-130 P&J and a coating thickness of 13-25 mm for reel-up and slitter-winder applications, and 15-35 P&J and 18-25 mm for film coating applications, as well as 10-50 P&J and 13-30 mm for press applications. In accordance with the disclosure of the publication, the coatings protecting the sensor and/or forming a groove can be made of the same material or of different materials, there can be one or more layers, and the coating layer can also lie under the sensor, coating hardnesses being of the order of 1-250 P&J, preferably in the range of 10-130 P&J, and the thickness of the coating being 0.1-60 mm, preferably 5-40 mm.

With respect to the state of the art, reference may also be made to FI patent application 20055019, which discloses a method for measuring the cross-direction tension profile of a web using at least one pressure-sensitive strip sensor placed spirally helically in connection with the surface of a roll to measure the force caused by the web, in which the active zone or zones of a film functioning as the measuring sensor visit during each revolution of the roll substantially completely under a web-wrap area and substantially completely in a free space. The publication also discloses a roll for measuring a tension profile, in which a spiral helical pressure sensor strip is mounted on the surface of a roll, which pressure sensor strip meets the web obliquely and the measuring distance of which in the direction of the web is substantially equal to or shorter than the wrap angle of the web when the roll is used for measuring the cross-direction tension profile of the web. The publication describes arrangements in which the sensor is under a protective layer, the sensor is mounted in a protective groove or on the surface of a roll without a protective groove. A ceramic resin composite coating is mentioned as an example of a protective layer.

As known in the state of the art, roll coatings wear and may be damaged during use and therefore it is necessary to replace them from time to time and, in connection with replacement, when a worn/damaged roll coating is replaced, the sensor located under it may also be easily damaged. The roll coating can also wear unevenly, so that it must be straightened to ensure the operation of the roll; the roll coating being typically dimensioned so that it also comprises a given allowance for straightening, which, however, is naturally not sufficient for several straightening operations, which means that the entire remaining coating layer has to be removed, and the sensor is thus damaged and needs to be replaced with a new one. To keep the sensor undamaged in connection with roll coating replacement has thus proved problematic in the measuring rolls of the state-of-the-art fibre-web machines of the type described above.

In the state-of-the-art measuring rolls, the sensor is thus typically placed under a soft coating layer onto the surface of the roll or in a groove made into the coating of the roll, with the result that the sensor area forms an area which is weaker than the other areas with respect to the attachment of the roll coating. When a soft coating is used, the coating does not necessarily protect the turning or grinding of the coating. In that case, the coating can detach locally and even air pockets may be formed.

An object of the invention is to eliminate or at least minimize the drawbacks and problems of the state-of-the-art arrangements described above.

With a view to achieving the objects described above as well as those coming out later, the measuring roll according to the invention is mainly characterized by what is stated in the characterizing part of claim 1.

The method for coating a measuring roll of a fibre-web machine according to the invention is mainly characterized by what is stated in the characterizing part of claim 10.

The method for replacing a coating of a measuring roll of a fibre-web machine according to the invention is in turn mainly characterized by what is stated in the characterizing part of claim 11.

In accordance with the invention, a measuring roll of a fibre-web machine, advantageously a measuring roll of a reel-up, is provided which comprises at least two coating layers placed on top of a sensor mounted in connection with the roll, of which coating layers at least the uppermost is softer than one of the layers under it. The coating layer advantageously placed on top of the sensor in connection with the invention is made of a relatively hard material, so that it stays well in place during use and, on the other hand, in connection with coating replacement it protects the sensor well when a softer coating layer to be replaced is removed.

The coating layer protecting the sensor in the measuring roll in accordance with the invention comprises at least one or more coating layers and, likewise, the coating layer proper of the roll can be formed of one or more coating layers.

In accordance with an advantageous embodiment of the invention, the measuring roll of the fibre-web machine comprises a protective coating layer which is placed on top of the sensor and remains, at least in substantial part, on top of the sensor when the roll coating proper or part of it is replaced. The measuring roll can comprise, for example, a polyurethane coating as the roll coating proper, which is replaced when needed, the uppermost coating layer or part of it being removed and the lower protective coating layer being left substantially in place in connection with replacement. In this way, the sensor remains undamaged under the protective layer and a new roll coating proper is coated on top. The protective coating layer lasts substantially for the entire life of the sensor or can be recoated at least once.

In accordance with an advantageous embodiment of the invention, when coating a roll that is provided with a pressure sensitive/force sensitive sensor and measures a tension and/or nip load profile, at least two coating layers are placed on the sensor, of which layers at least the uppermost coating layer is renewable/replaceable and at least one lower layer is permanent and shields the sensor in connection with the replacement of the coating.

In accordance with an advantageous additional feature of the invention, the coating layer protecting the sensor is made of a material that also forms a moisture barrier so that moisture cannot damage the sensor.

In connection with the invention, a polyurethane, epoxy resin, rubber or composite material is advantageously used as the coating protecting the sensor, the hardness of which material is below 30 P&J (⅛ inch point), preferably below 15 P&J (⅛ inch point), and its thickness is 10-15 mm, preferably 6-8 mm.

In the measuring roll in accordance with the invention, the at least one second outer, softer coating layer provided in addition to the protective layer advantageously has a hardness of 80-120 P&J (⅛ inch point), so that, for example, in reel-up applications the coating conforms to the variations in the surface of the roll, sealing the nip and, at the same time, enabling measurement across the entire width of the roll, also in respect of the hardness of the roll. The thickness of the softer coating layer is advantageously 5-30 mm, typically it is thicker than the layer protecting the sensor, preferably 5-20 mm.

The sensor in the measuring roll in accordance with the invention is advantageously a pressure sensitive/force sensitive measuring sensor, preferably a pressure sensitive/force sensitive film or strip sensor, for example, a so-called EMFi (Electro Mechanical Film) film sensor, so that by means of the measuring film it is possible to measure, for example, nip load and the CD profile of nip force in an easy and accurate manner.

The measuring roll in accordance with the invention is advantageously applied in connection with reel-ups of fibre webs, in particular paper webs, but it can also be applied, for example, as a measuring roll used in presses and surface-sizing units.

The measuring roll in accordance with the invention can be used, for example, for measuring a nip pressure/nip force profile, the measuring roll forming a nip with another roll/a web reel, and the measurement being carried out by means of a measuring film sensor mounted on the surface of the roll shell of the measuring roll.

In the following, the invention will be described in greater detail with reference to the FIGURE in the appended drawing, to the details of which the invention is, however, by no means intended to be narrowly limited.

The FIGURE schematically shows a partial sectional view of one embodiment of the invention.

As shown in the FIGURE, a sensor 12, preferably a pressure sensitive/force sensitive film sensor, is placed on the surface of a roll shell 11 of a measuring roll 10 of a fibre-web machine in accordance with the invention. In the embodiment shown in the FIGURE, the sensor 12 is placed in a groove 13 made into the surface of the roll shell 11. A protective coating layer 14 made of a relatively hard material is placed on top of the roll shell 11 and the sensor 12. On top of the protective coating layer 14 there is a coating layer proper 15 of the roll 10, which layer 15 is made of a material that is softer than the protective coating layer. In connection with replacement of the coating layer proper 15 of the roll 10, this coating layer proper 15 or part of it is removed, and the protective coating layer 14 remains substantially in place, protecting the sensor 12. A new coating layer proper of the roll 10 is thus coated on top of the protective coating layer 14. Both the protective coating layer 14 and the coating layer proper 15 can be formed of one or more coating layers.

Above, the invention has been described only with reference to some of its preferred embodiments, but the invention is not by any means intended to be narrowly limited to the details of them.

1. A measuring roll of a fibre-web machine, which roll has a shell on whose surface a sensor is arranged, and which roll is coated with a coating layer proper, wherein the roll comprises at least one protective coating layer placed under the coating layer proper and on top of the sensor in such a way that when the coating layer proper is replaced, the protective coating layer remains substantially on top of the sensor and the roll shell when the coating layer proper is removed.

2. A measuring roll as claimed in claim 1, wherein the protective coating layer is made of a harder material than the coating layer proper.

3. A measuring roll as claimed in claim 1, wherein the protective coating layer comprises one or more coating layers.

4. A measuring roll as claimed in claim 1, wherein the coating layer proper comprises one or more coating layers.

5. A measuring roll as claimed in claim 1, wherein the roll comprises a roll shell whose surface comprises a groove for the sensor.

6. A measuring roll as claimed in claim 1, wherein the sensor is a pressure sensitive/force sensitive film or strip sensor.

7. A measuring roll as claimed in claim 1, wherein the measuring roll is arranged to form a measuring roll in a fibre-web reel-up.

8. A measuring roll as claimed in claim 1, wherein the hardness of the protective coating layer is below 30 P&J (⅛ inch point), preferably below 15 P&J (⅛ inch point).

9. A measuring roll as claimed in claim 1, wherein the hardness of the coating layer proper is 80-120 P&J (⅛ inch point).

10. A method for coating a measuring roll of a fibre-web machine, in which method a sensor is disposed on the surface of a shell of the measuring roll, and in which method the roll is coated with a coating layer proper, comprising the method step of coating the roll, before the roll is coated with the coating layer proper, with at least one protective coating layer placed on top of the sensor in such a way that when the coating layer proper is replaced, the protective coating layer remains substantially on top of the sensor and the roll shell when the coating layer proper is removed.

11. A method for replacing a coating of a measuring roll in a fibre-web machine, in which method a coating layer proper of the measuring roll is replaced at least partly, comprising the method steps of removing the coating layer proper of the measuring roll at least partly and, when removing the coating layer proper, a sensor protective coating layer disposed on the surface of a roll shell of the measuring roll remaining substantially in place, and coating a new coating layer proper on top of the protective coating layer.
